(19) United States
(12) Patent Application Publication
(10) Pub. No.: US 2019/0042781 A1
(43) Pub. Date: Feb. 7, 2019

(54) Secure Storage Device

(71) Applicant: Bitdefender IPR Management Ltd., Nicosia (CY)

(72) Inventors: Sandor LUKACS, Floresti (RO); Dan C. TURICU, Baia Mare (RO)

(21) Appl. No.: 16/045,115

(22) Filed: Jul. 25, 2018

Related U.S. Application Data
(60) Provisional application No. 62/541,505, filed on Aug. 4, 2017.

(51) Int. Cl. G06F 21/62; G06F 21/60; G06F 3/06; G06F 21/56

(52) U.S. Cl. CPC G06F 21/6218; G06F 21/602; G06F 3/0622; G06F 21/56; G06F 3/0676; G06F 3/0677; G06F 3/0679; G06F 3/0655

(57) ABSTRACT

Described systems and methods allow protecting a host system against computer security threats, and in particular against ransomware and unauthorized access to private data. In some embodiments, a conventional non-volatile storage unit (e.g., magnetic, optical, or solid state drive) is paired with a dedicated security processor, forming a secure storage device which may connect to the primary processor of the host system via a conventional storage interface, such as a SATA, PCI, or USB connector. The primary processor and the security processor exchange messages and data via the storage interface. The security processor controls access of the primary processor to the storage unit, and may execute security and data encryption operations.

### RELATED APPLICATIONS

This application claims the benefit of the filing date of U.S. provisional patent application No. 62/541,505, filed on Aug. 4, 2017, entitled “Secure Storage Device”, the entire contents of which are incorporated by reference herein.

### BACKGROUND

The invention relates to computer security, and in particular to protecting a computer against malicious software (malware).

Malicious software affects a great number of computer systems worldwide. In its many forms such as computer viruses, worms, rootkits, and spyware, malware presents a serious risk to millions of computer users, making them vulnerable to loss of data and sensitive information, identity theft, and loss of productivity, among others. Ransomware is a particularly dangerous type of malware, that encrypts a set of files found on a storage medium such as a computer's hard drive, and then asks an owner of the files to pay to recover the respective data.

Anti-malware software may be used to detect and/or incapacitate malicious software. However, malware employs various strategies to evade detection. One such strategy involves obfuscation, for instance encrypting the malicious code, or using slightly different code versions on each infected computer (a feature commonly known as polymorphism). Another exemplary detection avoidance method divides malicious activities among a plurality of agents, wherein each agent performs a separate set of actions, that cannot be considered malware-indicative when taken in isolation.

There is a strong interest in developing robust systems and methods for protecting digitally stored data from theft and unauthorized modification, including by malicious software.

### SUMMARY

According to one aspect, a computer system comprises a first hardware processor and a secure storage device, the secure storage device connected to the first hardware processor via a storage interface configured to receive storage access requests formatted according to a storage transmission protocol. The secure storage device comprises a second hardware processor and a non-volatile storage unit. The first hardware processor is configured, in response to detecting a request by software executing on the first hardware processor to store a data packet on the storage unit, to encrypt the data packet. The first hardware processor is further configured, in response to encrypting the data packet, to transmit a true storage access request to the storage interface, the true storage access request comprising the encrypted data packet. The first hardware processor is further configured to generate a dummy storage access request according to the storage transmission protocol, the dummy storage access request comprising at least a part of a cryptographic key, and to transmit the dummy storage access request to the storage interface. The second hardware processor is configured, in response to receiving a communication via the storage interface, to determine whether the communication comprises the dummy storage access request. In response, when the communication comprises the dummy storage access request the second hardware processor is configured to determine the cryptographic key according to the dummy storage access request. The second hardware processor is further configured, in response to receiving the true storage access request, to employ the cryptographic key to decrypt the data packet, and to determine whether the decrypted data packet comprises malicious software.

According to another aspect, a secure storage device comprises a first hardware processor and a non-volatile storage unit, the secure storage device configured to connect to a second hardware processor via a storage interface configured to receive storage access requests formatted according to a storage transmission protocol. The second hardware processor is configured, in response to detecting a request by software executing on the second hardware processor to store a data packet on the storage unit, to encrypt the data packet. The second hardware processor is further configured, in response to encrypting the data packet, to transmit a true storage access request to the storage interface, the true storage access request comprising the encrypted data packet. The second hardware processor is further configured to generate a dummy storage access request according to the storage transmission protocol, the dummy storage access request comprising at least a part of a cryptographic key, and to transmit the dummy storage access request to the storage interface. The first hardware processor is configured, in response to receiving a communication via the storage interface, to determine whether the communication comprises the dummy storage access request. In response, when the communication comprises the dummy storage access request, the first hardware processor is configured to determine the cryptographic key according to the dummy storage access request. The first hardware processor is further configured, in response to receiving the true storage access request, to employ the cryptographic key to decrypt the data packet, and to determine whether the decrypted data packet comprises malicious software.

According to another aspect, a computer security method comprises connecting a secure storage device to a first hardware processor via a storage interface configured to receive storage access requests formatted according to a storage transmission protocol, wherein the secure storage device comprises a second hardware processor and a non-volatile storage unit. The method further comprises, in response to detecting a request by software executing on the first hardware processor to store a data packet on the storage unit, employing the first hardware processor to encrypt the data packet. The method further comprises, in response to encrypting the data packet, employing the first hardware processor to transmit a true storage access request to the storage interface, the true storage access request comprising the encrypted data packet. The method further comprises employing the first hardware processor to generate a dummy storage access request according to the storage transmission protocol, the dummy storage access request comprising at least a part of a cryptographic key, and employing the first hardware processor to transmit the dummy storage access request to the storage interface. The method further comprises, in response to receiving a communication via the storage interface, employing the second hardware processor to determine whether the communication comprises the dummy storage access request. In response, when the communication comprises the dummy storage access request, the method further comprises employing the second hardware processor to employ the cryptographic key to decrypt the data packet; and employing the second hardware processor to determine whether the decrypted data packet comprises malicious software.

### BRIEF DESCRIPTION OF THE DRAWINGS

The foregoing aspects and advantages of the present invention will become better understood upon reading the following detailed description and upon reference to the drawings where:

FIG. 1 illustrates an exemplary hardware configuration of a host system protected from computer security threats according to some embodiments of the present invention.

FIG. 2 shows an exemplary hardware configuration of a secure storage device according to some embodiments of the present invention.

FIG. 3-A shows exemplary software components executing on a protected host system according to some embodiments of the present invention.

FIG. 3-B illustrates an alternative set of software components according to some embodiments of the present invention.

FIG. 4 shows exemplary software components executing within the secure storage device according to some embodiments of the present invention.

FIG. 5 shows an exemplary set of steps carried out by the computer security module (CSM) of FIGS. 3-A-B according to some embodiments of the present invention.

FIG. 6 shows an exemplary sequence of steps carried out by software executing within the secure storage device, according to some embodiments of the present invention.

FIG. 7 illustrates an exemplary sequence of steps performed by software executing within the secure storage device to maintain a storage semantic map according to some embodiments of the present invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. Computer readable media encompass non-transitory media such as magnetic, optic, and semiconductor storage media (e.g. hard drives, optical disks, flash memory, DRAM), as well as communication links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

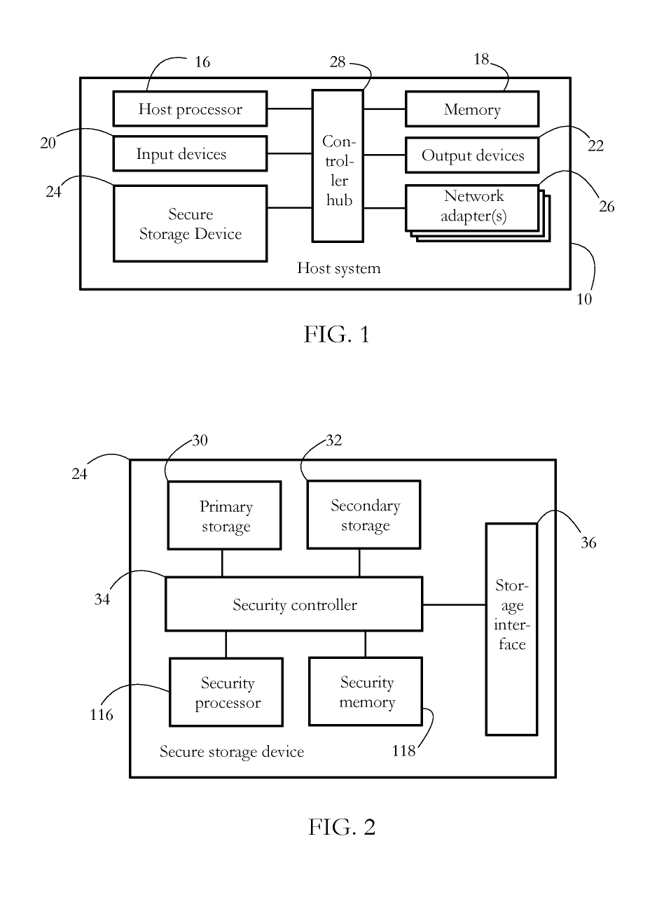

FIG. 1 shows an exemplary hardware configuration of a host system 10 protected against computer security threats according to some embodiments of the present invention. Exemplary host systems 10 include computers (e.g., a personal computer, a corporate server, etc.), mobile computing devices (e.g., laptops, tablet PC's), telecommunication devices (e.g., smartphones), digital appliances (TV's, game consoles, etc.), wearable computing devices (e.g., smartwatches), or any other electronic device having a processor and a memory, and requiring computer security protection. For simplicity, the illustrated host system is a computer system; the hardware configuration of other host systems such as mobile telephones, smartwatches, etc., may differ somewhat from the illustrated configuration.

Host system 10 comprises a set of physical devices, including a hardware processor 16 and a memory unit 18. In some embodiments, processor 16 comprises a physical device (e.g. a microprocessor, a multi-core integrated circuit formed on a semiconductor substrate, etc.) configured to execute computational and/or logical operations with a set of signals and/or data. In some embodiments, such operations are delivered to processor 16 in the form of a sequence of processor instructions (e.g. machine code or other type of encoding). Memory unit 18 may comprise volatile computer-readable media (e.g. DRAM, SRAM) storing instructions and/or data accessed or generated by processor 16.

Input devices 20 may include devices enabling a user to introduce data and/or instructions into host system 10, together with the respective hardware interfaces and/or adapters making such introduction possible. Exemplary input devices include, among others, a button, a keyboard, a mouse, a joystick, a touchscreen, a microphone, a camera, a game controller, a gesture detection system, and a motion detection sensor. Output devices 22 may include display devices such as monitors and speakers among others, as well as hardware interfaces/adapters such as graphic cards, allowing host system 10 to communicate data to a user. In some embodiments, input devices 20 and output devices 22 may share a common piece of hardware, as in the case of touch-screen devices. Network adapter(s) 26 enable host system 10 to connect to a communication network, such as a local area network (LAN) and/or to other devices/computer systems.

A secure storage device 24 includes computer-readable media enabling the non-volatile storage, reading, and writing of software instructions and/or other data. Exemplary storage devices 24 include magnetic, optical, and flash memory devices, as well as removable media such as CD and/or DVD disks and drives. In some embodiments, secure storage device 24 is endowed with other hardware and software components specifically configured to enhance the security of stored data, as shown in detail below.

In some embodiments, controller hub 28 includes the plurality of system, peripheral, and/or chipset buses, and/or all other circuitry enabling the communication between processor 16 and devices 18, 20, 22, 24, and 26. Exemplary components of controller hub 28 include a memory controller, an input/output (I/O) controller, and an interrupt controller. Depending on hardware manufacturer and device, some or all such controllers may be incorporated into a single integrated circuit, and/or may be integrated with processor 16. In some embodiments, some other devices, such as graphics adapters forming part of output devices 22, may be also integrated with processor 16.

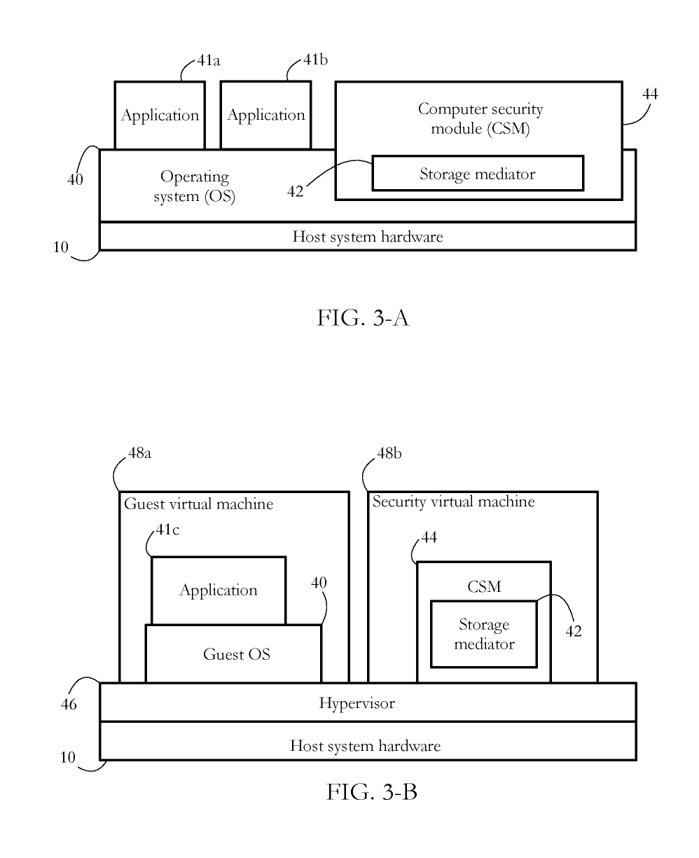

FIG. 2 shows an exemplary hardware configuration of secure storage device 24 according to some embodiments of the present invention. Some embodiments mitigate the risk posed by malicious software by pairing a conventional storage device—a primary storage 30 (e.g., magnetic or solid state drive) with a dedicated security processor 116 separate from the primary processor of host 10. This auxiliary processor may be integrated with the storage unit and/or additional hardware on a common printed circuit board which assumes a conventional hard drive form factor. In another exemplary embodiment, secure storage device 24 may be packaged as an external mass storage device (e.g., flash drive, external hard drive), which may connect to host system via a conventional interface such as a universal serial bus (USB) or a Thunderbolt® interface/connector.

Primary storage 30 may act as the de facto storage device for host system 10. As such, primary storage 30 may store code and/or data belonging to an operating system and/or other software applications executing on host processor 16, as well as a user's data such as documents, images, sound files, etc.

Security processor 116 comprises a physical electronic circuit (e.g., integrated circuit formed on a semiconductor substrate) configured to perform mathematical and/or logical operations with a set of signals and/or data. In some embodiments, processor 116 is a multipurpose, generic microprocessor of a type used as central processing unit (CPU) in personal computers and/or mobile telephones. Examples of such processors are conventional processors from manufacturers such as Intel®, AMD®, and ARM®. In an alternative embodiment, processor 116 comprises a customized electronic circuit such as an application-specific integrated circuit (ASIC), or a field-programmable gate array (FPGA). Other embodiments of processor 116 include a graphics processing unit (GPU), or a combination of the above. Using such specialized processors may be advantageous in that their architecture may be especially crafted and optimized for parallel computation and certain specialized tasks. A parallel, specialized architecture may benefit applications such as encryption/decryption, as further described below.

Additional hardware components of secure storage device 24 may include a security memory 118 providing volatile computer-readable media (e.g. DRAM, SRAM) for storing instructions and/or data accessed or generated by processor 116. Device 24 may further comprise a security controller 34 generically representing buses and/or all other circuitry interconnecting the hardware components of device 24. Secure storage device 24 may further connect to controller hub 28 of host system 10 by way of a storage interface 36 (e.g., a Serial AT Attachment—SATA, or PCI Express interface and/or connector).

In some embodiments, secure storage device 24 may further include a secondary storage device 32 comprising non-volatile computer-readable media. In some embodiments, primary storage 30 and secondary storage 32 are implemented as distinct logical partitions of a single physical mass storage device—magnetic, optical, or solid state drive. Secondary storage 32 may be invisible to software executing on processor 16, and may only be accessible to software executing on auxiliary security processor 116. Such isolation may be achieved using hardware logic (circuitry of security controller 34) configured to expose a limited range of storage addresses to host processor 16.

Secondary storage 32 may be used to store security code and data such as malware-indicative signatures, among others. Secondary storage 32 may further store code to be executed by processor 116 at startup (boot-up). Some embodiments of secure storage device 24 use secondary storage 32 to store an encoding of a file system semantic map, as shown in more detail below. Other embodiments of storage 32 may store partial copies (e.g., backups) of data stored in primary storage 30.

In some embodiments, primary storage 30 and secondary storage 32 are addressable via a set of location indicators (addresses). Depending on implementation, storage 30, 32 may be divided into individual addressable units, for instance sectors, blocks, and/or clusters.

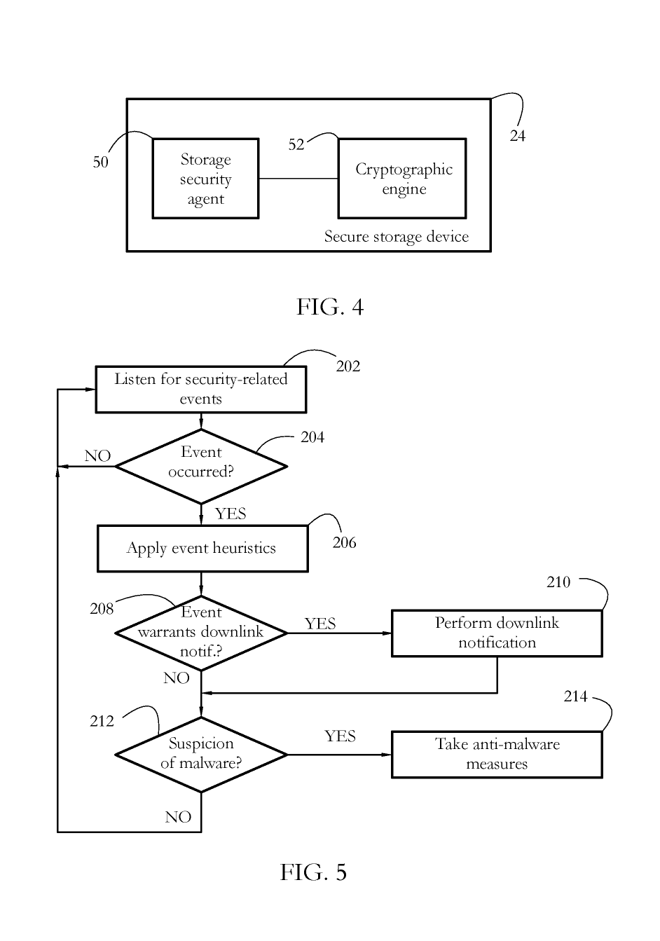

FIG. 3-A shows exemplary software components executing on host processor 16 according to some embodiments of the present invention. An operating system (OS) 40 comprises a set of computer programs providing an interface between the hardware of host system 10 and other software such as applications 41a-b. OS 40 may comprise any widely available operating system such as Windows®, MacOS®, Linux®, iOS®, or Android®, among others. Applications 41a-b generically represent any computer programs, including word processors, spreadsheet applications, imaging applications, games, browsers and electronic communication applications, among others.

Some embodiments of the present invention further include a computer security module (CSM) 44 comprising software protecting host system 10 against malware. CSM 44 may include, for instance, computer programs for detecting malicious software, and/or computer programs for incapacitating such software. Such components may employ any method known in the art of computer security. In some embodiments, CSM 44 further comprises a storage mediator component 42 operating as an interface between OS 40 and secure storage device 24. An exemplary storage mediator 42 may operate as a storage driver enabling reading and writing of data from/to primary storage 30. Storage mediator 42 may be further configured to exchange messages and/or data with software executing on security processor 116, as shown in more detail below.

FIG. 3-B shows an alternative embodiment operating in a hardware virtualization environment, for instance, in a cloud computing application. A virtual machine (VM) is a term used in the art to describe an emulation of an actual physical machine/computer system, the VM capable of running an operating system and other applications. A hypervisor includes software configured to create or enable a plurality of virtualized devices, such as a virtual processor and a virtual MMU, and to present such virtualized devices to software in place of the real, physical devices of host system 10. Such operations are commonly known as exposing a virtual machine. Hypervisors may enable sharing of hardware resources of host system 10 by multiple virtual machines, and may further manage such multiplexing so that each VM operates independently and is unaware of other VMs executing concurrently on the respective host. Examples of popular hypervisors include the VMware vSphere™ from VMware Inc. and the open-source Xen hypervisor, among others. In the present description, software is said to execute within a virtual machine when it executes on a virtual processor of the respective virtual machine.

In the exemplary configuration illustrated in FIG. 3-B, a hypervisor 46 exposes a guest VM 48a. An operating system and a set of user applications execute within a guest virtual machine 48a, while CSM 44 executes within a dedicated security virtual machine 48b separate from guest VM 48a. In an alternative embodiment to FIG. 3-B, CSM 44 and/or storage mediator 42 may comprise a set of libraries loaded/called by hypervisor 46. As such, CSM 44 and/or storage mediator 42 may execute below guest VM 48a, at a processor privilege level of hypervisor 46 (e.g., ring −1 or VMXroot on Intel® platforms). Configurations such as illustrated in FIG. 3-B may preferable to the one illustrated in FIG. 3-A because of increased security. The virtual environments of guest VM 48a and security VM 48b may be relatively well isolated from each other, so that malicious software executing within guest VM 48a cannot infect or otherwise interfere with software executing within security VM 48b.

FIG. 4 shows an exemplary set of software components executing within secure storage device 24 (i.e., on processor 116) according to some embodiments of the present invention. Illustrated software includes a storage security agent 50 and a cryptographic engine 52. Agent 50 may be configured to maintain a file system semantic map of primary storage 30 and to apply a set of heuristics (e.g., decision rules) to determine whether a request by software executing on host processor 16 to access primary storage 30 is indicative of a computer security threat. Engine 52 may be configured to perform encryption and/or decryption operations on data packets coming to and/or from primary storage 30. The operation of components 50 and 52 will be detailed below.

In some embodiments, CSM 44 collaborates with software executing within secure storage device 24 (e.g., security agent 50), for instance by exchanging notifications/signals via a communication channel managed by storage mediator 42. Exemplary notifications from processor 16 to secure storage device 24 (herein referred to as downlink notifications) include an indicator of an operation to be performed by processor 116, and other data such as a filename, an encryption key, a set of flags, etc. CSM 44 may also send downlink notifications in response to certain security-relevant events, as detailed further below.

An exemplary communication channel may use the regular means of transporting data between a processor and a mass storage unit. For instance, CSM 44 and security agent 50 may exchange messages according to a storage transmission protocol such as the Serial ATA or small computer system interface (SCSI) protocols. The storage transmission protocol establishes a format of a communication via the storage interface, the size and contents of a frame/packet, the count, size, order, and/or format of headers and/or payload, the significance of various control bits and data fields, the encoding of commands, etc.

In some embodiments, a downlink notification is disguised as a dummy access request. Dummy access requests herein refer to storage access requests which are properly formatted according to the communication protocol (e.g. well-formed SATA commands), but are not supposed to be carried out as such, instead being interpreted as notifications. The term “dummy” is used to distinguish such requests from “true” or “genuine” storage access requests representing storage access operations intended to be carried out as such.

In some embodiments, dummy requests are invalid storage access requests, in the sense that executing one such dummy request causes an exception/fault. In such cases, a fault handler may intercept the respective fault and determine the request causing the respective fault as a downlink notification. In other embodiments, dummy requests are not faulty per se, but may comprise specific, unusual, or contradictory combinations of parameter values (flags). In yet other embodiments, dummy requests may comprise valid, regular requests; such dummy requests may be identified as such e.g., according to a content of the payload or of other data fields defined by the storage communication protocol.

One example of dummy access request comprises a request to access an out-of-range address, i.e., an address outside the normal addressable range of primary storage 30. Examples include ‘read block B’, or ‘write payload P at address A’, wherein the address of block B and address A are outside of the normal addressable range of primary storage 30. Each such address (specific value of A and/or B) may correspond to a specific instruction or event communicated to software executing inside secure storage device 24. In another example, downlink notifications may be disguised as requests to access storage at an address which, although within the normal addressable range, is not commonly accessed during normal operation. For instance, a request to write to a storage location currently holding a master boot record (MBR) or a critical OS component (e.g., NTOSKRNL.EXE in Windows®) may be intercepted by secure storage device 24 and interpreted as downlink notification from CSM 44.

In yet another example, dummy access requests may be identified according to specific payload contents (e.g., a particular bit pattern or signature). In such embodiments, a software component executing on security processor 116 may parse payload contents to detect dummy access requests. Various payloads P may correspond to various notifications/instructions to secure storage device 24.

In yet another example, dummy access requests may be identified as such according to a content of another data field defined by the storage communication protocol, for instance, according to a content of a ‘Command’ and/or ‘Auxiliary’ fields specified in the Serial ATA protocol. In one such example, a command to update malware signatures may be encoded into the ‘Command’ field of a dummy access request issued by CSM 44. The actual signatures may be transmitted as the payload of another dummy access request.

Some other examples of downlink notifications include an instruction to scan data stored at a particular storage location: the respective location may be encoded into the payload of a dummy access request. In yet another example, dummy write requests comprising distinct addresses A may indicate distinct anti-malware methods or parameters. Each address or range of addresses A may indicate a distinct heuristic or a distinct group of malware-indicative signatures.

In turn, storage mediator 42 may receive notifications/signals from device 24 (herein referred to as uplink notifications) via an acknowledgement and/or another form of response to a downlink notification, for instance via hardware interrupts—IRQs, or asynchronous SATA notifications sent by device 24 and handled by storage mediator 42 and/or by another event handler of OS 40. Exemplary uplink notifications include, among others, a security alert, for instance an indicator of a probable ransomware attack, and an indicator of an attempt to update a firmware of storage device 24.

Yet another exemplary uplink notification comprises a request for a cryptographic key. In one such example, security agent 50 may detect an attempt to write an encrypted data packet. Such an attempt may indicate that automatic encryption of disk data is activated (e.g., Bitlocker® technology from Microsoft®). In response, some embodiments may request a cryptographic key from CSM 44. More details of this method are given further below.

Some embodiments implement a version of iterative malware detection using a sequence of downlink-uplink notifications. In one such example, a downlink notification instructs storage security agent 50 to scan a particular file for malware. Agent 50 may then communicate a result of the scan to CSM 44, which may select another file or folder according to the result of the first scan and communicate the new scan target to security agent 50 via a new downlink notification, etc. Such iterative schemes may enable fairly complex malware detection procedures having to install complex software on secure storage device 24.

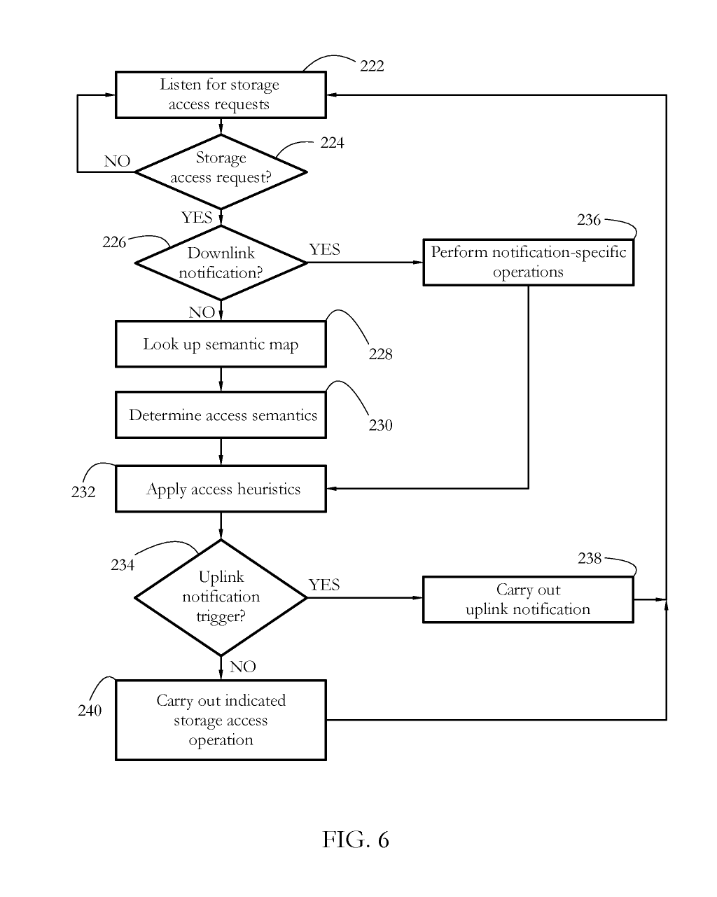

FIG. 5 shows an exemplary sequence of steps performed by CSM 44 according to some embodiments of the present invention. CSM 44 may aggregate security-related data from a plurality of sources within host system 10, and may receive notifications about the occurrence of certain events during execution of software. One exemplary source is a system call function of OS 40, which is modified by hooking to signal to CSM 44 every time the respective system call occurs. Other exemplary sources of security information and notifications include OS minifilters. In some embodiments, CSM 44 may further receive uplink notifications about from secure storage device 24. In response to detecting the occurrence of an event, in a step 206 CSM 44 may apply a set of heuristics to determine whether host system 10 is currently under attack. When the analysis reveals a suspicion of malware, CSM 44 may take appropriate anti-malware measures (steps 212-214), for instance blocking or otherwise preventing execution of a malicious process, and alerting a user or an administrator of host system 10. Some detected events warrant a downlink notification to secure storage device 24. In one such example, CSM 44 may direct security agent 50 to perform an investigation of a storage access attempt. Downlink notifications are illustrated as steps 208-210 in FIG. 5.

In some embodiments, storage security agent 50 re-creates the semantics of the file system used by OS 40 from metadata stored on storage 30, in a manner which is independent of the file system of OS 40. Stated otherwise, agent 50 maintains a file system semantic knowledgebase amounting to an alternative or shadow of the file system of OS 40. In conventional computer systems, at the hardware level data is stored as blocks that lack semantic information. For instance, it is not clear which chunk of data belongs to which file/folder. A further complication is fragmentation, wherein a single file's data is not stored contiguously, but is dispersed at various locations throughout the storage medium. The bookkeeping task of associating assets with storage locations and transforming hardware-level information into meaningful data is commonly taken up by the OS. The OS manages such tasks by maintaining a specialized data structure known as a file system, encoded as metadata and stored within a particular section of the storage medium. Exemplary file systems include FAT, FAT32, and NTFS, among others.

In some embodiments, the file system semantic map comprises an encoding of a mapping between a section of primary storage 30 and an item of a file system of OS 40. Exemplary file system items include a directory and a file. An exemplary semantic map item associates a range of addresses [A1 A2] with a file F (wherein F may be represented as a path, e.g., C:\user\docs\Letter.txt or /home/user/docs/Letter.txt). Such an association effectively indicates that data stored in the respective range of addresses forms a part of file F. Another exemplary file system semantic map item specifies that the range of addresses [A3 A4] stores file system metadata. Yet another exemplary file system semantic map item associates an individual addressable unit (e.g., storage block or sector, as opposed to address range) with a file system item. Semantic map data may be encoded using any method known in the art, for instance as a bitmap, linked list, etc.

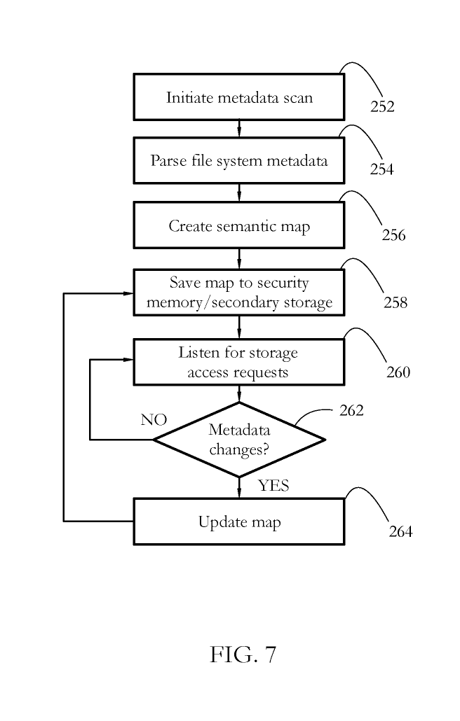

FIG. 6 shows an exemplary sequence of steps performed by storage security agent 50 according to some embodiments of the present invention. Agent 50 receives storage access requests from OS 40 via storage interface 36. A typical request includes an indicator of an operation (read, write), an indicator of an address, and a payload. Exemplary storage access requests have the semantics of “read a block of N bytes at address A” and “write payload P at address A”. Access requests may further comprise a set of parameter values (e.g., flags, attributes) of the respective request. The actual format and encoding of storage access requests may vary among hardware and software implementations.

When an access request arrives at device 24, agent 50 may determine according to parameters of the request whether the respective request indicates a true storage access or a dummy storage access (i.e., a notification from CSM 44). In one exemplary embodiment, a request to access an out-of-range address may indicate such a notification. When the respective access request comprises a downlink notification, a step 236 may select and perform a specific action according to parameters of the respective request (see some examples below).

In a sequence of steps 228-230, security agent 50 may further decode the semantics of the respective storage access request according to the semantic map. For instance, agent 50 may determine whether what is being written is metadata or an actual file, whether a new file is being created, which particular file is currently being written or read, etc. A further step 232 may apply a set of access heuristics to determine whether the requested access is indicative of a computer security threat. When no, agent 50 may allow the respective access to proceed. When heuristics indicate that the requested access request warrants notifying computer security module 44, agent 50 may perform an uplink notification amounting to a security alert.

FIG. 7 shows an exemplary sequence of steps carried out by storage security agent 50 to maintain the file system semantic map. Map creation may be initiated, for instance, at boot-up. In some embodiments, agent 50 may determine a location on primary storage 30 where file system metadata used by OS 40 is stored. Several methods for achieving this are known in the art of computer forensics. Some embodiments use a software component executing on the host (e.g., CSM 44) to determine the location of file system data. CSM 44 may then communicate the respective location to security agent 50 using downlink notifications.

In a sequence of steps 254-256, agent 50 parses file system metadata stored in primary storage 30 and assembles the semantic map according to the respective metadata. Some embodiments store the determined semantic map data (i.e., shadow file system) in security memory 118 and/or secondary storage 32. Then, during execution of software on processor 16, agent 50 may listen for storage access requests and determine whether such requests indicate a change in metadata (for instance, file/directory creation or deletion). When yes, agent 50 may update the semantic map accordingly (steps 260-262-264 in FIG. 7).

The illustrated system of notifications and heuristics may be used for a variety of applications, some examples of which are given below.

### Command Filtering to Protect Hardware

Carefully crafted malicious software may exploit certain features of the ATA command set (e.g., the DOWNLOAD MICROCODE command) to surreptitiously update a storage device's firmware thereby introducing hardware-level malware into the device itself. One such exemplary malware is a backdoor which may be used by software executing on the host to alter the behavior of and/or control the respective storage device.

To prevent such advanced attacks, in some embodiments storage security agent 50 is configured to filter storage access requests received via storage interface 36. The filtering rules may be basic, for instance, only allow execution of most common access requests (e.g., commands for reading, writing, identifying a device, etc.), and block all other commands/requests. Other embodiments may implement more sophisticated filtering heuristics, for instance filtering rules adapted to the current context. In another example, security agent 50 may condition execution of certain ATA commands/access requests upon an explicit confirmation from an administrator of host system 10.

In some embodiments, certain commands/requests are not blocked, but instead emulated and further analyzed by software executing on security processor 116 (e.g., by security agent 50). In response to receiving such a command, security software may return an artificial response, to trick software executing on host processor 16 into believing that the respective command/access request was successfully carried out. Security agent 50 may further log such commands, to aid anti-malware research.

### Event Interception and Interpretation at Hardware Level

Maintaining the semantic map (shadow file system) enables storage security agent 50, in response to receiving an access request, to detect security-relevant events occurring during execution of software on processor 16. For instance, in response to a write request, agent 50 may determine whether what is being written is metadata or actual contents of a file, whether the respective write is directed to an empty storage section or is overwriting existing information, whether the respective write is a genuine write or a downlink notification from processor 16, etc.

File system events such as file creation, file deletion, and file rewrite are carried out according to event-specific sequences of operations. An exemplary pattern may include a metadata read, followed by a metadata write, followed by a payload write. Agent 50 may use a set of heuristics that encode such patterns, to identify a type of each file system event. Furthermore, agent 50 may identify the target of each read/write operation, e.g., which file is being written to, which file is being read.

In contrast to conventional computer security systems/methods, such event interception occurs virtually without the knowledge of software executing on processor 16. Therefore, malicious software may not prevent or otherwise interfere with the event detection. Security software such as agent 50 may then notify the occurrence of certain events deemed relevant to security to CSM 44 using uplink notifications.

### On-Access Malware Scanning

Security agent 50 may detect an attempt to open a file and/or an attempt to execute an executable file. Other operations that may be detected in this manner include a file append and an allocation of storage for subsequent writes. Each such event may be used as a trigger to launch a scan of the respective file, or a scan of a resource (main executable, library, etc.) belonging to the process that ordered the respective storage access. The scan may be carried while the process that issued the storage access request is suspended, or offline while the respective process is allowing to continue execution.

The scan may be performed according to any method known in the art of computer security, e.g., by matching a content of the respective file against a library of malware-indicative signatures or code patterns. A library of malware-indicative signatures may be stored on secondary storage 32 for this purpose. The library may be kept up to date via periodic or on demand updates. Some embodiments update the signature library and/or other software executing on secure storage device 24 via a set of downlink notifications (e.g., dummy storage access requests).

In a variant of on-access scanning, agent 50 may use a set of heuristics to detect a boot sequence of host system 10 and/or OS 40. Stated otherwise, by analyzing a sequence of storage access requests, agent 50 may determine that host system 10 is currently in the process of booting (i.e., hardware and/or software initialization). An exemplary boot sequence typically begins with a sequence of read requests from a location storing a data structure known as the master boot record (MBR) or GUID partition table (GPT).

Identify Device

| | | |
|---|---|---|
| Read DMA Ext | A: 00000000 | C: 0001 |
| Read DMA Ext | A: 00000000 | C: 0001 |
| Read DMA Ext | A: 00000001 | C: 0001 |
| Read DMA Ext | A: E8E088AF | C: 0001 |
| Read DMA Ext | A: 00000002 | C: 0020 |
| Read DMA Ext | A: E8E0888F | C: 0020 |
| Read DMA Ext | A: 00000002 | C: 0020 |
| . . . | | |

An exemplary sequence of storage access requests indicating that OS 40 has started loading is illustrated below:

Identify Device

| | | | |
|---|---|---|---|
| Read FPDMA Queued | A: 00000000 | C: 0001 | T: 04 |
| Read FPDMA Queued | A: 00000001 | C: 0001 | T: 05 |
| Read FPDMA Queued | A: 00000002 | C: 0020 | T: 06 |
| Read FPDMA Queued | A: 00000000 | C: 0001 | T: 07 |
| . . . | | | |

Another typical feature of a boot sequence of access requests comprises very long sequences of read requests (e.g., 2-3000 consecutive read requests) interrupted by short sequences of 2-5 write requests. Such patterns may be OS-specific. Pattern analysis may combine a count of consecutive read/write requests with an analysis of address information and/or of other parameter values to infer various stages of the boot process.

Some embodiments may combine access request pattern matching with semantic map information, to detect an initialization of OS 40. In one such example, security agent 50 may carry an iterative procedure to harvest information about the type and/or location of software executing on host processor 16, directly from storage access events. By detecting access to the master boot record, agent 50 may determine partition information. Then, a series of read requests are targeted at the volume headers. From such requests, agent 50 may determine and validate information about the respective volumes. Next, agent 50 may automatically identify a storage location of a set of important OS files (e.g., resources that OS 40 loads upon initialization, such as NTOSKRNL.EXE in Windows®), by following the sequence of reads and/or writes that accompanies the boot. The respective boot sequence may also reveal a type of operating system (e.g., make, version, etc. of OS 40).

Some embodiments may then scan every file that is being opened during a time period (e.g., several seconds) following the detected boot/initialization phase. Scanning may include integrity verification, i.e., determining whether the content of a file have been corrupted, for instance by malicious software. Integrity verification may comprise comparing a hash of the current content of the respective file with a reference hash stored on secondary storage 32.

In yet another exemplary application related to boot sequences, some embodiments may use secure storage device 24 as an agent executing outside OS 40 and configured to test the integrity and/or trustworthiness of OS 40. For instance, agent 50 may automatically detect a request to reboot host system 10. Then, in response to detecting that the reboot is actually underway (e.g., from device detection and initialization operations, or in response to a downlink notification by CSM 44), agent 50 may suspend the normal boot sequence and expose an alternative OS or security agent configured to scan data structures of OS 40 and/or the boot area of primary storage 30. When the scan is complete and the system deemed safe, agent 50 may resume booting of OS 40.

### Protecting Stored Assets

The boot area of primary storage 30 typically stores resources that are read before the OS is loaded. By maintaining the semantic map, agent 50 may determine whether a write request targets the respective boot area, and in response, may block the respective write and/or notify CSM 44. A similar strategy may be used to protect valuable assets of OS 40 or other applications, such as certain files, libraries, etc.

Operating with Encrypted Data

Some versions of OS 40 have the option to keep data in encrypted form on primary storage 30. One such example is the Bitlocker® feature of Microsoft® Windows®. When stored data is encrypted, an entity executing outside OS 40 (including storage security agent 50) may not have access to the respective data, or to system metadata that allow construction of the file system semantic map.

However, agent 50 may collaborate with CSM 44 to obtain an encryption key, or information conducive to deriving the respective key. Such information may include, for instance, a password, a secret, a nonce, etc., and is hereby termed encryption key material. CSM 44 may expose a user interface requesting a user password or another secret used in relation to the respective key, and communicate the password/secret to agent 50. In another embodiment, CSM 44 may interface directly with the OS's encryption agent (e.g., Bitlocker® modules) to obtain key material. In response to obtaining key material, CSM 44 may communicate the key material itself, or a storage location of said key material, to agent 50 via a downlink notification (e.g., a dummy storage access request).

Once in possession of the encryption key, agent 50 may use cryptographic engine 52 to decrypt stored data in order to construct and/or maintain the file system semantic map. In some embodiments, agent 50 may further use the encryption key to perform online scanning/analysis of data traffic to and/or from primary storage 30, virtually without knowledge of OS 40 or of other software executing on host processor 16. In one example, in response to intercepting a write request, security agent 50 may decrypt and analyze the respective payload, before writing the original (encrypted) payload to the intended address. In some embodiments, in response to decrypting the respective payload, agent 50 may save an unencrypted version of the payload to secondary storage 32.

### Generic Encryption Detection

Some embodiments of storage security agent 50 may automatically determine whether data stored within a section (e.g., block, sector, etc.) of storage 30 is encrypted or not. Such determinations may use information complexity measures such as entropy or other methods known in the art. To avoid false positives, some embodiments may use metadata available for the respective file to determine whether the respective file is likely to have high entropy without necessarily being encrypted. Such examples include data compressed according to formats such as MP3, JPG, MPG, ZIP, etc. To determine whether the respective file falls into one of these categories, some embodiments may locate the header section of the respective file according to metadata, and search for file type information in the respective header.

In some embodiments, each entry of the file system semantic map may be augmented with a set of flags, indicating for instance whether the respective file system item (file, folder, etc.) is encrypted or not, whether the respective file system item is compressed or not, etc. The flags may be maintained by agent 50 together with the rest of the semantic map data.

### Detection of Advanced Ransomware

The systems and methods described herein allow automatically detecting an attempt to encrypt stored data. The detection is performed independently from, and is virtually undetectable by, software executing on processor 16. A useful application of such automatic encryption detection comprises detection of ransomware and other type of malicious software whose actions include the unauthorized or unintended encryption of user data.

One exemplary detection heuristic comprises detecting an attempt to overwrite unencrypted content with encrypted content. Another set of detection heuristics employ statistics to compare the current stream of storage access requests to a “normal” pattern corresponding to a specific user and/or a running application. To achieve detection, some embodiments determine a set of user profiles and/or application profiles indicating, for instance, what applications/processes are likely to be launched by a particular user, what storage locations are typically accessed by the respective user, what is the typical pattern of storage requests associated with each process/application, etc. When a current sequence of storage access requests leaves the pattern of “normality”, for instance when agent 50 detects an unusual spike in file creation activity, wherein the content of the respective files is encrypted, agent 50 may determine that a ransomware attack is underway.

When agent 50 detects suspicious encryption activity, agent 50 may suspend the respective activity (for instance, block a set of suspicious writes), and/or signal to CSM 44 using the uplink notification mechanism. In turn, CSM 44 may use the notification as a warning of a possible attack, or may apply extra heuristics, for instance to correlate events notified by agent 50 with other malware-indicative events occurring on host system 10 or on other computers connected to host system 10 over a communication network.

### Asset Shadowing for Applications Such as Software Versioning and Backup

In some embodiments, storage security agent 50 automatically detects an attempt to delete or overwrite a file, and in response, saves a copy of the deleted/overwritten data to a separate location, either on primary storage 30 or on secondary storage 32. A shadow copy of the file being deleted or overwritten is thus kept alongside the newly written data. Some embodiments save more than two consecutive versions of the same file, wherein at least one of the respective versions is unencrypted. This mechanism may allow a safe recovery of data, by potentially restoring the respective file to any of the saved versions.

Possible applications of such asset shadowing include security, backup, and software versioning, among others. In a computer security embodiment, agent 50 may detect, for instance, that a particular file is repeatedly overwritten within a relatively short time interval. Such file activity may be malware-indicative. Some embodiments may compare successive versions of the same file, to determine, for instance, whether a newer version is encrypted while an older one is not. As mentioned before, such changes in encryption may indicate a ransomware attack. More generally, keeping a backup copy of a file may potentially prevent malicious software from modifying important OS assets, thus preventing malicious hooking of OS functions, for instance. When such a modification is detected, agent 50 may notify CSM 44. In turn, CSM 44 may instruct agent 50 to roll back changes to a particular file.

### Optimization

Some embodiments may be further optimized to lower the computational overhead of unscrambling file system semantics from the level of secure storage device 24. In a hybrid embodiment, semantics indicators are delivered from CSM 44 to security agent 50, while agent 50 may intercept and counteract malicious storage events such as file deletion, file overwrite, unauthorized data encryption, etc. In such embodiments, CSM 44 may comprise a lightweight storage access filter having a functionality similar to that of a file system minifilter in Windows®. The storage access filter may determine, for instance, an attempt to write to a file, a name and/or disk location of the respective data/file, and an identity of a process carrying out the write operation, among others. Then the storage access filter may transmit such semantic information to storage security agent 50 via a downlink notification. Agent 50 may acknowledge receipt using an acknowledgement packet or an uplink notification. In some embodiments, downlink notifications are added to a notification queue.

At the level of secure storage device 24, agent 50 may identify an attempt to write and try to match the respective attempt it with data from the downlink notification queue. A successful match allows agent 50 to determine the semantics of the respective write attempt, which may allow agent 50 to apply more sophisticated heuristics to determine whether the respective write attempt is suspicious, needs to be prevented, etc. A failure to match a write attempt detected at hardware level (i.e., from specific metadata changes) to a write attempt conveyed via a downlink notification may indicate malicious software capable of avoiding detection by the storage access minifilter of OS 40. In such cases, security agent 50 may block the respective write attempt and/or notify CSM 44 via an uplink notification.

The present invention relates to systems and methods for protecting a host system against computer security threats such as malicious software, among others. The described systems and methods are particularly suited for protecting host systems (e.g., computers, mobile communication devices, etc.) against sophisticated malware that is capable of subverting conventional defenses. Exemplary applications include protection against ransomware and the theft of proprietary, private, and/or confidential data.

Some embodiments of the present invention rely on the observation that malicious software may successfully interfere in the traffic of data between the processor of the host system and non-volatile storage (e.g., magnetic, optical, or solid state drive). Security software executing on the respective processor may be unable to block or prevent all such interference, resulting in a substantial risk of data theft or loss. To address this problem, exemplary embodiments of the present invention displace parts of the security software onto a separate processor configured to intercept, analyze, and/or selectively block data traffic between the main processor of the host system and the storage device. The auxiliary security processor may be integrated with the storage device and/or additional hardware, for instance on a common printed circuit board, to form an enhanced secure storage device. Said secure storage device may assume a conventional form factor of a hard drive or other non-volatile storage, and may connect to the rest of the hardware of the host system via a conventional storage interface/connector, such as a serial AT attachment (SATA) or peripheral component interconnect (PCI) Express interface/connector. In an alternative embodiment, the secure storage device (i.e., storage+auxiliary processor) may be packaged as an external drive, connected to the host system for instance by way of a universal serial bus (USB) or another conventional interface/connector.

In conventional anti-malware systems, prevention, detection, and countermeasures are implemented in software executing on the same physical processor that also runs the malicious code. Furthermore, in conventional systems, both malware and legitimate software can access the same physical storage device (e.g., hard drive). Such configurations potentially allow carefully-crafted malicious code to undermine the security software. In contrast, in some embodiments of the present invention, access to physical storage is controlled by an auxiliary processor, distinct from the main processor running the user applications (and potentially, malicious code). Security software executing on the auxiliary processor is therefore out of the reach of malware.

It will be clear to one skilled in the art that the above embodiments may be altered in many ways without departing from the scope of the invention. Accordingly, the scope of the invention should be determined by the following claims and their legal equivalents.

What is claimed is:

1. A computer system comprising a first hardware processor and a secure storage device, the secure storage device connected to the first hardware processor via a storage interface configured to receive storage access requests formatted according to a storage transmission protocol, wherein the secure storage device comprises a second hardware processor and a non-volatile storage unit, and wherein:
the first hardware processor is configured to:
in response to detecting a request by software executing on the first hardware processor to store a data packet on the storage unit, encrypt the data packet,
in response to encrypting the data packet, transmit a true storage access request to the storage interface, the true storage access request comprising the encrypted data packet,
generate a dummy storage access request according to the storage transmission protocol, the dummy storage access request comprising at least a part of a cryptographic key, and
transmit the dummy storage access request to the storage interface; and
the second hardware processor is configured to:
in response to receiving a communication via the storage interface, determine whether the communication comprises the dummy storage access request;
in response, when the communication comprises the dummy storage access request, determine the cryptographic key according to the dummy storage access request,
in response to receiving the true storage access request, employ the cryptographic key to decrypt the data packet, and
determine whether the decrypted data packet comprises malicious software.

2. The host system of claim 1, wherein the second hardware processor is further configured, in response to determining whether the decrypted data packet comprises malicious software, when the decrypted data packet comprises malicious software, to transmit a notification formatted according to the storage transmission protocol to the storage interface, the notification configured to cause the first hardware processor to interpret the notification message as a security alert.

3. The host system of claim 2, wherein the notification is configured to cause a hardware interrupt in the first hardware processor.

4. The host system of claim 1, wherein the communication comprises an address indicative of a location on the storage unit, and wherein the second hardware processor is configured to determine whether the communication comprises the dummy storage access request according to the address.

5. The host system of claim 4, wherein determining whether the communication comprises the dummy storage access request comprises:
comparing the address to a predetermined address; and
in response, determining that the communication comprises the dummy storage access request according to a result of the comparison.

6. The host system of claim 1, wherein the communication comprises a request to write a payload to the storage unit, and wherein the second hardware processor is configured to determine whether the communication comprises the dummy storage access request according to the payload.

7. The host system of claim 1, wherein the second hardware processor is further configured to:
maintain a shadow file system comprising a mapping between a plurality of data packets stored on the storage unit and a plurality of files of a primary file system maintained by an operating system executing on the first hardware processor;
in response to receiving the true storage access request, identify according to the shadow file system a file of the plurality of files, so that the data packet forms a part of the file; and
in response to identifying the file, determine whether the file comprises malicious software.

8. The host system of claim 1, wherein the second hardware processor is further configured to:
determine according to the shadow file system whether another communication received from the first hardware processor via the storage interface indicates a creation of a new file; and
in response, when the another communication indicates the creation of the new file, update the shadow file system to indicate the creation of the new file.

9. The host system of claim 1, wherein the second hardware processor is further configured, in response to decrypting the data packet, to write the decrypted data packet to the storage unit.

10. The host system of claim 1, wherein the storage interface comprises an item selected from a group consisting of a serial ATA interface and a universal serial bus (USB) interface.

11. A secure storage device comprising a first hardware processor and a non-volatile storage unit, the secure storage device configured to connect to a second hardware processor via a storage interface configured to receive storage access requests formatted according to a storage transmission protocol, wherein:
the second hardware processor is configured to:
in response to detecting a request by software executing on the second hardware processor to store a data packet on the storage unit, encrypt the data packet,
in response to encrypting the data packet, transmit a true storage access request to the storage interface, the true storage access request comprising the encrypted data packet,
generate a dummy storage access request according to the storage transmission protocol, the dummy storage access request comprising at least a part of a cryptographic key, and
transmit the dummy storage access request to the storage interface; and
the first hardware processor is configured to:
in response to receiving a communication via the storage interface, determine whether the communication comprises the dummy storage access request;
in response, when the communication comprises the dummy storage access request, determine the cryptographic key according to the dummy storage access request,
in response to receiving the true storage access request, employ the cryptographic key to decrypt the data packet, and
determine whether the decrypted data packet comprises malicious software.

12. A computer security method comprising:
connecting a secure storage device to a first hardware processor via a storage interface configured to receive storage access requests formatted according to a storage transmission protocol, wherein the secure storage device comprises a second hardware processor and a non-volatile storage unit;
in response to detecting a request by software executing on the first hardware processor to store a data packet on the storage unit, employing the first hardware processor to encrypt the data packet;
in response to encrypting the data packet, employing the first hardware processor to transmit a true storage access request to the storage interface, the true storage access request comprising the encrypted data packet;
employing the first hardware processor to generate a dummy storage access request according to the storage transmission protocol, the dummy storage access request comprising at least a part of a cryptographic key;
employing the first hardware processor to transmit the dummy storage access request to the storage interface;
in response to receiving a communication via the storage interface, employing the second hardware processor to determine whether the communication comprises the dummy storage access request;
in response, when the communication comprises the dummy storage access request, employing the second hardware processor to employ the cryptographic key to decrypt the data packet; and
in response to decrypting the data packet, employing the second hardware processor to determine whether the decrypted data packet comprises malicious software.

13. The method of claim 12, further comprising, in response to determining whether the decrypted data packet comprises malicious software, when the decrypted data packet comprises malicious software, employing the second hardware processor to transmit a notification formatted according to the storage transmission protocol to the storage interface, the notification configured to cause the first hardware processor to interpret the notification message as a security alert.

14. The method of claim 13, wherein the notification is configured to cause a hardware interrupt in the first hardware processor.

15. The method of claim 12, wherein the communication comprises an address indicative of a location on the storage unit, and wherein the second hardware processor is configured to determine whether the communication comprises the dummy storage access request according to the address.

16. The method of claim 15, wherein determining whether the communication comprises the dummy storage access request comprises:
employing the second hardware processor to compare the address to a predetermined address; and
in response, determining that the communication comprises the dummy storage access request according to a result of the comparison.

17. The method of claim 12, wherein the communication comprises a request to write a payload to the storage unit, and wherein the second hardware processor is configured to determine whether the communication comprises the dummy storage access request according to the payload.

18. The method of claim 12, further comprising:
employing the second hardware processor to maintain a shadow file system comprising a mapping between a plurality of data packets stored on the storage unit and a plurality of files of a primary file system maintained by an operating system executing on the first hardware processor;
in response to receiving the true storage access request, employing the second hardware processor to identify according to the shadow file system a file of the plurality of files, so that the data packet forms a part of the file; and
in response to identifying the file, employing the second hardware processor to determine whether the file comprises malicious software.

19. The method of claim 12, further comprising:
employing the second hardware processor to determine according to the shadow file system whether another communication received from the first hardware processor via the storage interface indicates a creation of a new file; and
in response, when the another communication indicates the creation of the new file, employing the second hardware processor to update the shadow file system to indicate the creation of the new file.

20. The method of claim 12, further comprising, in response to decrypting the data packet, employing the second hardware processor to write the decrypted data packet to the storage unit.

21. The method of claim 12, wherein the storage interface comprises an item selected from a group consisting of a serial ATA interface and a universal serial bus (USB) interface.
